(19) United States
(12) Patent Application Publication
(10) Pub. No.: US 2026/0370163 A1
(43) Pub. Date: Nov. 19, 2026

(54) MOTOR CONTROL CIRCUIT, MOTOR CONTROL CHIP, AND MOTOR CONTROL SYSTEM

(71) Applicant: AMICRO TECHNOLOGY CO., LTD., Zhuhai (CN)

(72) Inventors: Qinwei LAI, Zhuhai (CN); Gangjun XIAO, Zhuhai (CN)

(73) Assignee: AMICRO TECHNOLOGY CO., LTD., Zhuhai (CN)

(21) Appl. No.: 19/731,391

(22) Filed: Jul. 6, 2026

Related U.S. Application Data
(63) Continuation of application No. PCT/CN2024/141885, filed on Dec. 24, 2024.

(30) Foreign Application Priority Data
Feb. 29, 2024 (CN) 202410226629.1

(51) Int. Cl. H02P 7/29

(52) U.S. Cl. CPC H02P 7/29; H02P 2201/07

(57) ABSTRACT

A motor control circuit includes a buck-boost controller, a motor gate driver, a first switching transistor, a second switching transistor, and a third switching transistor. The buck-boost controller is configured to: in a case of detecting that a charging device is inserted and receiving a request to enter a driving operation mode, charge a battery and allocate a supply current to a motor; in a case of detecting that the charging device is inserted and receiving a charging instruction signal, step down a voltage at a system voltage node to a target stepped-down voltage; and in a case of detecting that no charging device is inserted and receiving the request to enter the driving operation mode, step up the voltage at the system voltage node to a target stepped-up voltage.

### CROSS-REFERENCE TO RELATED APPLICATIONS

This application is a continuation of International Application No. PCT/CN2024/141885, filed on Dec. 24, 2024, which claims priority to Chinese Patent Application No. 202410226629.1, filed on Feb. 29, 2024. All of the aforementioned applications are incorporated herein by reference in their entireties.

### TECHNICAL FIELD

The present disclosure relates to the field of motor control circuits, in particular to a motor control circuit for charging and driving, a motor control chip, and a motor control system.

### BACKGROUND

Currently, many devices are powered by a single lithium battery, e.g., small household appliances, toys, and the like. In a scenario where power is supplied by the single lithium battery, there exists such a problem that the consumption of electric energy of the battery increases along with an increase in the operating time, and a voltage of the battery becomes unstable. This adversely affects the performance of an analog device, e.g., a reference voltage is set to be too low. When an external switching transistor needs to be driven and the voltage of the battery drops, an on-resistance of an N-Metal-Oxide-Semiconductor (NMOS) transistor for controlling the operation of a motor is large, so a driving capability decreases.

In the related art, the battery is charged using a Buck circuit, but an alternating current is introduced for the rectification between the alternating current and a direct current, or it is only suitable for charging rather than a driving operation mode.

### SUMMARY

An object of the present disclosure is to provide a motor control circuit, a motor control chip, and a motor control system. The technical solutions of the present disclosure will be described as follows.

The present disclosure provides in some embodiments a motor control circuit, including a buck-boost controller, a motor gate driver, a first switching transistor, a second switching transistor, and a third switching transistor.

The first switching transistor, the second switching transistor and the third switching transistor are all connected to the buck-boost controller, the first switching transistor is connected to the second switching transistor, and the second switching transistor is connected to the third switching transistor;
the first switching transistor is connected to the second switching transistor at a system voltage node;
the buck-boost controller is configured to, in a case of detecting that a charging device is inserted and receiving a charging command signal, turn on the first switching transistor to input a voltage to the system voltage node, or in a case of detecting that the charging device is inserted and receiving a request to enter a driving operation mode, turn on the first switching transistor to input a voltage to the system voltage node;
the buck-boost controller is configured to, in a case of detecting that the charging device is inserted and receiving the request to enter the driving operation mode, control the second switching transistor and the third switching transistor to charge a battery and allocate a supply current to a motor;
the buck-boost controller is configured to, in a case of detecting that the charging device is inserted and receiving the charging command signal, control the second switching transistor and the third switching transistor to step down a voltage at the system voltage node to a target stepped-down voltage, and convert the target stepped-down voltage into a charging voltage for the battery; and
the buck-boost controller is configured to, in a case of detecting that no charging device is inserted and receiving the request to enter the driving operation mode, turn off the first switching transistor, and control the second switching transistor and the third switching transistor to step up the voltage at the system voltage node to a target stepped-up voltage, to allow that the motor gate driver indirectly controls operation of the motor according to the target stepped-up voltage.

As compared with the related art, the buck-boost controller in the embodiments of the present disclosure regulates the voltage at the system voltage node through two switching transistors and an inductor, without introducing any alternating current for rectification conversion between the alternating current and a direct current, so as to step down the voltage to charge the battery without affecting the operation of the motor, and maintain the voltage at the system voltage node for the operation of the motor through step-up regulation in a case that the battery does not need to be charged. As a result, it is able to solve the problems of a low supply voltage and an unstable voltage caused when the battery is used for a long time period, charge the battery, and prevent the motor from being not driven due to a large on-resistance of the switching transistor.

The present disclosure further provides in some embodiments a motor control chip, including the above-mentioned motor control circuit. The motor control chip is provided with a system voltage pin, and the system voltage node is connected to the system voltage pin of the motor control chip.

The present disclosure further provides in some embodiments a motor control system, including the above-mentioned motor control chip. The motor control chip is externally connected to an inductor, a motor, a battery, and a fourth switching transistor; the fourth switching transistor, the motor, the battery, the inductor and the motor control chip are sequentially connected to form a loop; the second switching transistor, the third switching transistor, the inductor and the battery are sequentially connected to form a battery charging and discharging loop; and the motor control chip further includes a linear regulator and a diode, and the linear regulator is connected to the battery via the second switching transistor and the diode, to allow that a supply voltage of the battery is inputted to the linear regulator through the second switching transistor or the diode. The linear regulator is configured to regulate a voltage inputted into the linear regulator to provide an internal supply voltage for the motor control chip.

In summary, the voltage at the system voltage pin is regulated through the inductor externally connected to the motor control chip as well as the two switching transistors and the buck-boost controller built in the motor control chip, so as to prevent the operation of the motor from being affected in a process of stepping down the voltage to charge the battery, and maintain the voltage at the system voltage node for the operation of the motor through step-up regulation in a case that the battery does not need to be charged. As a result, it is able to solve the problems of a low supply voltage and an unstable voltage caused when the battery is used for a long time period, charge the battery, and prevent the motor from being not driven due to a large on-resistance of the switching transistor in the motor control chip.

The present disclosure further provides in some embodiments a motor control system, including a fourth switching transistor, an inductor, a motor, a battery, and the motor control circuit; or including a fourth switching transistor, an inductor, a motor, a battery, and the motor control chip. According to the motor control system in the embodiments of the present disclosure, in a case of detecting that the charging device is inserted and receiving the request to enter the driving operation mode, the buck-boost controller controls the second switching transistor and the third switching transistor to charge the battery and allocate a supply current to the motor. In a case of detecting that the charging device is inserted and receiving the charging command signal, or in a case of detecting that no charging device is inserted and receiving the request to enter the driving operation mode, the buck-boost controller controls the second switching transistor and the third switching transistor to step down or step up the voltage at the system voltage node, and performs duty cycle control on parameters such as the voltage generated at the system voltage pin through the inductor and internal switching logic circuits. Hence, through the motor control circuit or the motor control chip in conjunction with the inductor, it is able to charge the battery and step up the voltage to drive the motor.

### BRIEF DESCRIPTION OF THE DRAWINGS

FIG. 1 is a schematic view showing a motor control circuit according to an embodiment of the present disclosure.

FIG. 2 is a schematic view showing a motor control chip according to an embodiment of the present disclosure.

### DETAILED DESCRIPTION OF THE EMBODIMENTS

In the following description, specific details are set forth to provide a thorough understanding of the embodiments of the present disclosure. However, a person skilled in the art may implement the embodiments without these specific details. For example, a circuit is shown in a block diagram so as to avoid obscuring the embodiments with unnecessary details. In other circumstances, well-known circuits, structures and techniques may not be shown in details so as not to obscure the embodiments.

In a device powered by a single lithium battery, such as small household appliances or toys, a motor device is usually driven by a direct current source, and a control circuit of the motor device generally includes analog devices such as operational amplifier and analog-to-digital converter. As an operating time of the battery increases, a supply voltage provided by the battery changes, and the supply voltage received by the analog device is no longer a constant voltage. At this time, it is relatively difficult to reach a reference voltage required by the operational amplifier or analog-to-digital converter. For example, if the reference voltage required by the analog device is 4.2 V and the supply voltage provided by the battery is 5 V, the reference voltage generated through voltage division inside the analog device may reach 4.2 V, so the performance of the analog device is not adversely affected. However, if the supply voltage provided by the battery drops to 3.0 V, the reference voltage of 4.2 V cannot be generated inside the analog device, and instead, the reference voltage less than 3.0 V is generated through voltage division. The reference voltage is too low, so the performance of the analog device is deteriorated, an operating voltage of a chip built in the analog device becomes low or unstable, and the battery power continues to be consumed. In a case that an NMOS transistor is used to drive the motor and the battery voltage drops, an on-resistance of the NMOS transistor is negatively correlated with a voltage at a gate electrode of the NMOS transistor, so the lower the voltage provided by the battery, the higher the on-resistance of the NMOS transistor, resulting in a decrease in a driving capability of the NMOS transistor. Hence, the normal operation of the device powered by a single lithium battery (e.g., a motor device) may be adversely affected, and the motor device may not be driven due to the too high on-resistance of some driving branches. In the related art, a buck circuit is used to charge the battery, but an alternating current is introduced for the rectification conversion between the alternating current and a direct current, or it is only suitable for charging rather than a driving operation mode, i.e., it is impossible to power the motor while charging the battery under a low power consumption condition.

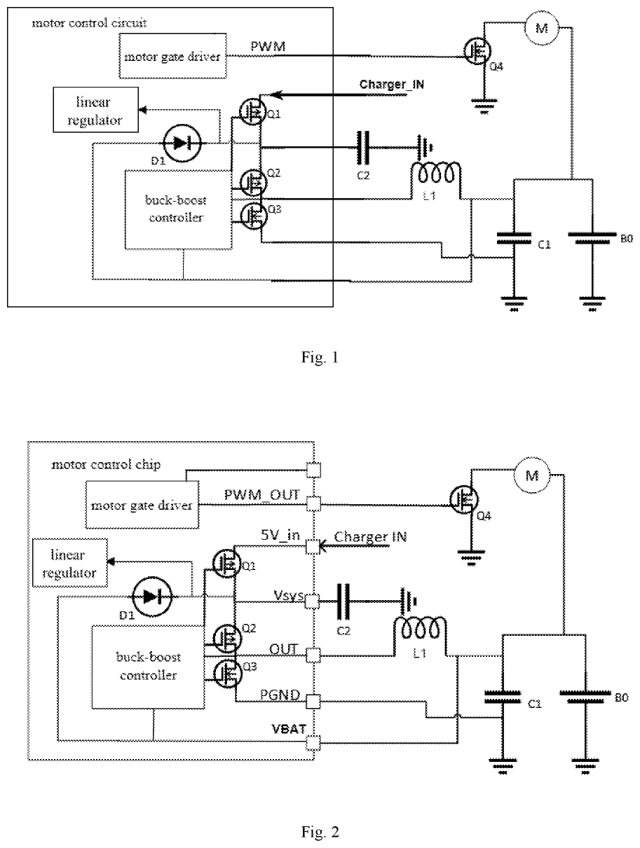

In order to solve at least one of the above-mentioned technical problems, the present disclosure provides in some embodiments a motor control circuit. The motor control circuit is a circuit integrated with a switch charging function and a boosting operation function to solve the problems of a low and unstable supply voltage. The motor control circuit includes a buck-boost controller, a motor gate driver, a first switching transistor, a second switching transistor, and a third switching transistor. The motor control circuit is externally connected to a fourth switching transistor, an inductor, a motor, and a battery. The buck-boost controller and the motor gate driver are combined to form a controller. Alternatively, the motor control circuit further includes a main controller, and the motor gate driver is a functional module of the main controller provided according to a motor driving function. The first switching transistor, the second switching transistor and the third switching transistor are all connected to the buck-boost controller, the first switching transistor is connected to the second switching transistor, and the second switching transistor is connected to the third switching transistor. Referring to FIG. 1, the second switching transistor Q2 is connected between the first switching transistor Q1 and the third switching transistor Q3. The buck-boost controller may also be considered as being connected between the first switching transistor Q1 and the third switching transistor Q3.

In the embodiments of the present disclosure, the first switching transistor and the second switching transistor are connected at a system voltage node, i.e., a connection node of the first switching transistor and the second switching transistor is the system voltage node. The system voltage node is connected to the battery through the second switching transistor and the inductor external to the motor control circuit. The battery is configured to power the motor. Illustratively, as shown in FIG. 1, the connection node of the first switching transistor Q1 and the second switching transistor Q2 (the system voltage node) is regarded as a power supply end, and it is grounded through a capacitor C2. The system voltage node is connected to a positive electrode of the battery B0 via the second switching transistor Q2 and the inductor L1 in sequence. The second switching transistor Q2 adjusts a current on-time to affect a charge/discharge amount of the battery B0, and the inductor L1 has an energy storage effect to affect the charge/discharge amount of the battery B0. In a case that a voltage at the system voltage node is dynamically adjusted by the buck-boost controller, both the supply voltage of the battery and the supply voltage of the motor may be stabilized.

In the embodiments of the present disclosure, the motor gate driver is connected to the motor through the fourth switching transistor external to the motor control circuit. As shown in FIG. 1, an output end of the motor gate driver is connected to the motor M through the fourth switching transistor Q4. In a driving operation mode, a duty cycle signal PWM outputted by the motor gate driver is used to control an on-time and an off-time of the fourth switching transistor Q4 to regulate a rotational speed of the motor. In order to provide a supply voltage or a supply current to the motor M, the fourth switching transistor Q4, the motor M and the battery B0 are sequentially connected to form a motor driving loop. Hence, a part of a charging current allocated to the battery is further allocated to the motor, so as to charge the battery and drive the motor to operate simultaneously.

The buck-boost controller is configured to, in a case of detecting that a charging device is inserted and receiving a charging command signal, turn on the first switching transistor to input a voltage to the system voltage node, and transmit a reference charging voltage from the charging device to the motor control circuit, i.e., control the first switching transistor to transmit the reference charging voltage provided by the charging device. Alternatively, the buck-boost controller is configured to, in a case of detecting that the charging device is inserted and receiving a request to enter a driving operation mode, turn on the first switching transistor to input a voltage to the system voltage node, and transmit the reference charging voltage from the charging device to the motor control circuit. In a case that the motor is driven to operate and the battery is charged simultaneously, the first switching transistor is controlled to transmit the reference charging voltage provided by the charging device, so as to provide the supply voltage.

Illustratively, the first switching transistor Q1 in FIG. 1 is connected to Charger_IN, and it means that the charging device is inserted. Specifically, a circuit where the buck-boost controller is located is connected to the charging device. Upon the receipt of the charging command signal, the first switching transistor Q1 is turned on. The charging device may be a charging power source. For example, in a case that the charging power source is inserted and the buck-boost controller detects a 5 V charging request signal, the first switching transistor Q1 is turned on and a voltage of 5 V provided by the charging device is transmitted through the first switching transistor Q1. In this way, in a case that both a charging operation and a motor driving operation are performed simultaneously, the buck-boost controller controls the input of the reference charging voltage through the first switching transistor Q1. Preferably, in the motor control circuit, a main controller is provided. when the main controller detects that the motor control circuit is physically connected to the charging device, it determines that the charging device is inserted. Then, upon the receipt of the charging command signal, the main controller enables the buck-boost controller to turn on the first switching transistor, so as to form an internal power supply path of the motor control circuit. The motor control circuit or the buck-boost controller enters a charging mode, and the buck-boost controller enables a Buck circuit for charging the battery. In a case that the battery is charged and the motor is driven simultaneously, part of the current for charging the battery may be supplied to the motor.

The buck-boost controller is configured to, in a case of detecting that the charging device is inserted and receiving the request to enter the driving operation mode, control the second switching transistor and the third switching transistor to charge the battery and allocate a supply current to the motor. In this case, in a charging mode or a driving operation mode, the reference charging voltage transmitted by the input end of the first switching transistor is stepped down at the system voltage node in a process of turning on or off the second switching transistor and the third switching transistor, and then the battery is charged with the stepped-down voltage through the inductor, so as to provide a charging current to the battery. The battery still provides a supply current to the motor, and the supply current may also come from the charging current. The actual power consumption of the motor always occurs at a node on a battery side, so the power from the battery is consumed by the motor, or part of the power is generated under the control of the buck-boost controller. In this way, the operation of the motor is not affected in a case that the charging device is inserted.

In some embodiments of the present disclosure, the energy stored in the inductor is converted into electric energy at a node where the inductor is connected to the battery. The electric energy is superimposed on the positive electrode of the battery and passes through the system voltage node, so as to increase the voltage at the system voltage node. When the fourth switching transistor is an NMOS transistor, the voltage is fed back to a gate electrode of the fourth switching transistor to reduce an on-resistance of the fourth switching transistor, and the fourth switching transistor is turned on according to a certain duty cycle to drive the motor to operate normally. After the buck-boost controller determines that the charging device is inserted, it supports to charge the battery. In a case that a normal state of the fourth switching transistor is not an off state, part of the supply current needs to be allocated by the battery for the normal operation of the motor, so the charging current reserved for the battery becomes smaller, and the power consumption for charging the battery is reduced.

The buck-boost controller is configured to, in a case of detecting that the charging device is inserted and receiving the charging command signal, control the second switching transistor and the third switching transistor to step down the voltage at the system voltage node to a target stepped-down voltage and convert the target stepped-down voltage into a charging voltage for the battery. At this time, the motor is supported to operate or the battery supplies power to the motor. The main controller enters a charging mode, and controls the second switching transistor and the third switching transistor to regulate the voltage at the system voltage node according to a voltage step-down logic of a buck converter. For example, referring to FIG. 1, the buck-boost controller applies a duty cycle control over the second switching transistor Q2 and another duty cycle control over the third switching transistor Q3. The current inputted to the second switching transistor Q2 is discontinuous, while the current outputted at the connection node of the second switching transistor Q2 and the third switching transistor Q3 is continuous. Hence, the voltage generated at the system voltage node in a case that the first switching transistor starts to transmit the reference charging voltage is reduced to the target stepped-down voltage. The buck-boost controller controls an output voltage at the connection node of the second switching transistor Q2 and the third switching transistor Q3 to be less than or equal to the reference charging voltage inputted to the input end of the first switching transistor Q1 (i.e., Charger_IN), so as to regulate an initial voltage at the system voltage node to the target stepped-down voltage according to the voltage step-down logic of the buck converter. The target stepped-down voltage is lower than the reference charging voltage or a maximum supply voltage of the battery (e.g., a voltage at the positive electrode of the battery when the battery is fully charged). Furthermore, the output voltage at the connection node of the second switching transistor Q2 and the third switching transistor Q3 corresponds to the charging voltage of the battery, i.e., the target stepped-down voltage is converted into the charging voltage of the battery. In FIG. 1, the connection node of the second switching transistor Q2 and the third switching transistor Q3 is connected to the positive electrode of the battery B0 through the inductor L1, so the current outputted from the connection node of the second switching transistor Q2 and the third switching transistor Q3 passes through the inductor L1. The charging voltage of the battery is divided and converted by the inductor L1 into magnetic energy for storage, and energy is stored by a capacitor connected in parallel with the battery B0 to maintain a constant voltage. Based on the above, the battery provides a stable supply voltage to the motor. In this way, the buck-boost controller has a step-down charging voltage regulation capability to meet the charging requirements of the battery.

The buck-boost controller is configured to, in a case that no charging device is inserted and the request to enter the driving operation mode is initiated, turn off the first switching transistor. At this time, the main controller starts the motor gate driver to control the motor to operate. In order to drive the motor to operate at a stable duty cycle and reduce an influence caused by any change in the supply voltage of the battery, the buck-boost controller controls the second switching transistor and the third switching transistor to step up a voltage at a system voltage pin to a target stepped-up voltage, so that the motor gate driver indirectly controls the motor to operate according to the target stepped-up voltage. That is, the motor gate driver outputs the target stepped-up voltage to the fourth switching transistor, and the fourth switching transistor controls the operation of the motor. At this time, a rotational speed of the motor is controlled by a corresponding duty cycle signal outputted by the motor gate driver, and a voltage in the corresponding duty cycle signal includes the target stepped-up voltage. The target stepped-up voltage is applied to a gate electrode of the fourth switching transistor, so as to reduce the on-resistance of the fourth switching transistor and turn the fourth switching transistor on, thereby to prevent the motor from being not driven due to a large on-resistance of the switching transistor.

Illustratively, in the driving operation mode, the buck-boost controller increases the voltage at the system voltage pin to a stable direct-current voltage of 5 V and supplies it to the motor. The target stepped-up voltage is preferably 5 V. The voltage at the system voltage pin, before being increased, is a relatively low voltage provided by the battery (the supply voltage of the battery drops after a long-term operation, resulting in the relatively low voltage). Hence, in the driving operation mode, the stepping up the voltage at the system voltage pin to the target stepped-up voltage may also be understood as a boosting process for the battery.

It should be appreciated that, the driving operation mode refers to a mode where the motor operates according to a predetermined driving capability in the presence of a certain supply current or supply voltage. In the embodiments of the present disclosure, the operation of the motor is controlled by the motor gate driver, and it is also affected by the control of the buck-boost controller over the charging and discharging of the battery. A power source of the motor includes the battery. The motor is a direct-current motor without any complex algorithm. The motor is controlled according to a duty cycle, and a magnitude of the duty cycle corresponds to the rotational speed of the motor. The predetermined driving capability includes data about a bus voltage, a bus current, a rotor position, a rotation speed, and a phase current of a motor winding.

Specifically, in a case of detecting that no charging device is inserted, the main controller enters the driving operation mode, i.e., the main controller sends a request to the buck-boost controller to enter the driving operation mode. In a case of detecting that no charging device is inserted and receiving the request to enter the driving operation mode, the buck-boost controller turns off the first switching transistor, and controls the second switching transistor and the third switching transistor to step up the voltage at the system voltage node to the target stepped-up voltage. After the buck-boost controller enters the driving operation mode or an equivalent operation mode for driving the motor, it is able to reduce the impact on the normal operation of the motor, and drive the motor while charging the battery. The buck-boost controller controls the second switching transistor and the third switching transistor to regulate the voltage at the system voltage node according to a voltage step-up logic of the boost converter. In a case that the first switching transistor stops transmitting an external voltage, the voltage generated at the system voltage node is dynamically stepped up to the target stepped-up voltage. Moreover, in order to support the step-up operation, the energy stored in the inductor L1 is converted into electric energy and superimposed on the energy of the battery, so as to supply energy to the motor. The voltage required by the motor gate driver to drive the motor is higher than the voltage at the positive electrode of the battery. Hence, a boosting logic function is realized through the inductor, the second switching transistor and the third switching transistor.

In summary, as compared with the related art, the buck-boost controller in the embodiments of the present disclosure regulates the voltage at the system voltage node through the two switching transistors and the inductor, without introducing any alternating current for the rectification conversion between the alternating current and a direct current, so as to prevent the operation of the motor from being affected in a process of stepping down the voltage to charge the battery, and maintain the voltage at the system voltage node for the operation of the motor through step-up regulation in a case that the battery does not need to be charged. As a result, it is able to solve the problems of a low supply voltage and an unstable voltage caused when the battery is used for a long time period, charge the battery, and prevent the motor from being not driven due to a large on-resistance of the switching transistor.

Based on the above, the buck-boost controller is configured to, in a case of detecting that the charging device is inserted and receiving the charging command signal, charge the battery using the converted charging voltage. The converted charging voltage is illustratively the output voltage at the connection node of the second switching transistor Q2 and the third switching transistor Q3 in FIG. 1 in a case that the input end of the first switching transistor Q1 is connected to Charger_IN, and it is a result of voltage division when the switching transistors are turned on. When the battery is fully charged, a stable supply voltage is maintained. Then, the second switching transistor and the third switching transistor are turned off to stop charging the battery, the charging is completed, and the buck converter built in the buck-boost controller is turned off or the buck logic is shut down. At this time, preferably, the first switching transistor is maintained in an on state to supply power to the motor control circuit, and the motor control circuit enters a standby state, or drives the motor to operate. If the main controller enters the standby state, it triggers the buck-boost controller to turn off both the second switching transistor and the third switching transistor, so no charging management is performed, no boosting is performed, and the motor is stopped from being driven to operate. At this time, the battery supplies power to the buck-boost controller and the motor through the inductor, and the supply voltage of the motor control circuit is switched to the supply voltage of the battery or a stable voltage less than the supply voltage of the battery (a voltage processed by a linear regulator or provided by another reference source), so as to guide the motor control circuit to be in the standby state with low power consumption.

In an embodiment of the present disclosure, the connection node of the second switching transistor and the third switching transistor is connected to the battery through the inductor. Specifically, the connection node of the second switching transistor and the third switching transistor is connected to one end of the inductor, the other end of the inductor is connected to one end of a first capacitor, the other end of the first capacitor is grounded, a connection node of the inductor and the first capacitor is connected to the positive electrode of the battery, and a negative electrode of the battery is grounded, so that a charging and discharging path is formed between the connection node of the second switching transistor and the third switching transistor and the battery. Illustratively, the inductor L1 is connected between the connection node of the second switching transistor Q2 and the third switching transistor Q3 and the positive electrode of the battery B0. The first capacitor C1 is connected in parallel with the battery B0, and the first capacitor C1 and the negative electrode of the battery B0 are both grounded. In a process of performing, by the buck-boost controller, the duty cycle control over the second switching transistor Q2 and the third switching transistor Q3, the first capacitor C1 filters the charging current, and it is also discharged to the connection node of the second switching transistor Q2 and the third switching transistor Q3. A connection node of the first capacitor C1 and the positive electrode of the battery B0 is connected to the buck-boost controller through the inductor L1, or directly connected to the buck-boost controller, so as to form two power supply paths, which include the charging and discharging path formed between the connection node of the second switching transistor and the third switching transistor and the battery. Energy is stored in a process of stepping down the voltage at the system voltage node. In addition, based on the voltage at the connection node of the second switching transistor and the third switching transistor, feedback is provided to the buck-boost controller to regulate the charging voltage of the battery or the voltage at the system voltage node. For example, in a case of an overcurrent, the buck-boost controller stops operating.

In an embodiment of the present disclosure, the buck-boost controller includes a drive enable end, a first switch drive end, a second switch drive end, and a drive output end. A first transmission end of the first switching transistor is configured to receive the reference charging voltage. A control end of the first switching transistor is connected to the drive enable end, so that the drive enable end controls the first switching transistor to be turned on or off. A second transmission end of the first switching transistor and a first transmission end of the second switching transistor are connected at the system voltage node, and in a case that the first switching transistor is turned on, the reference charging voltage is inputted to the system voltage node. A control end of the second switching transistor is connected to the first switch drive end. A second transmission end of the second switching transistor and a first transmission end of the third switching transistor are connected to one end of the inductor, and the other end of the inductor is connected to the positive electrode of the battery. A control end of the third switching transistor is connected to the second switch drive end, and a second transmission end of the third switching transistor is grounded, so as to control the second switching transistor through a duty cycle signal outputted by the first switch drive end and control the third switching transistor through a duty cycle signal outputted by the second switch drive end, thereby to satisfy the charging requirements of the battery and/or the driving requirements of the motor.

Specifically, in a case that the first switching transistor is turned on, the motor control circuit enters the charging mode, the reference charging voltage is inputted to the system voltage node, and the battery is charged through controlling the duty cycles of the second switching transistor and the third switching transistor. The battery also supports to allocate the supply current to the motor. After the charging is completed, the motor control circuit is switched to be in the standby state. In a scenario where no charging device is inserted, the first switching transistor is turned off so as to enable the motor control circuit to enter the driving operation mode, but the battery is not supported to be charged through controlling the reference charging voltage to be stepped down. Instead, the duty cycles of the second switching transistor and the third switching transistor are controlled to step up the voltage at the system voltage node, so as to drive the motor through controlling the fourth switching transistor. Hence, in the embodiments of the present disclosure, through the first switching transistor, it is convenient to detect whether the voltage at the system voltage node is provided by the inserted charging device or obtained through step-up in a case that no charging device is inserted. In the embodiments of the present disclosure, the second switching transistor and the third switching transistor are controlled through the duty cycle outputted by the first switch drive end and the duty cycle outputted by the second switch drive end respectively, so as to satisfy the charging requirements of the battery and/or the driving requirements of the motor. In a case that the battery power detected by the main controller is too low, there is a charging requirement, and the motor control circuit is connected to the charging device. The main controller sends the charging command signal to the buck-boost controller and the charging device is inserted, so as to charge the battery using the stepped-down voltage. In a case that the battery power detected by the main controller is sufficiently high (e.g., the voltage at the positive electrode of the battery is up to about 4 V), there is a driving requirement for the motor, and the main controller sends the request to enter the driving operation mode to the buck-boost controller, so as to step up the voltage at the system voltage node.

In addition, the connection node of the second transmission end of the second switching transistor and the first transmission end of the third switching transistor is connected to the drive output end. Referring to FIGS. 1 and 2, a drain electrode of the second switching transistor Q2 (P-channel Metal-Oxide-Semiconductor (PMOS) transistor) and a drain electrode of the third switching transistor Q3 (an NMOS transistor) are jointly connected to the drive output end in the buck-boost controller, so as to form a circuit for measuring the on-resistance of the second switching transistor Q2 and a circuit for measuring the on-resistance of the third switching transistor Q3. The buck-boost controller measures the on-resistance of the second switching transistor according to a voltage between the drive output end and a control end of the second switching transistor (the first switch drive end of the buck-boost controller) and a current flowing through the second switching transistor. The buck-boost controller further measures the on-resistance of the third switching transistor according to a voltage between the drive output end and a control end of the third switching transistor (the second switch drive end of the buck-boost controller) and a current flowing through the third switching transistor. The on-resistance of the second switching transistor changes along with the voltage at the control end of the second switching transistor, and the on-resistance of the third switching transistor changes along with the voltage at the control end of the third switching transistor. A source electrode of the third switching transistor is grounded, so as to provide a reference ground for the motor control circuit.

It should be appreciated that, the first switching transistor is a PMOS or NMOS transistor, the second switching transistor is a PMOS or NMOS transistor, and the third switching transistor is an NMOS transistor. To be specific, there are the following implementations.

In a case that the first switching transistor and the second switching transistor are both PMOS transistors and the third switching transistor is an NMOS transistor, the first transmission end of the first switching transistor is a source electrode of the first switching transistor, the second transmission end of the first switching transistor is a drain electrode of the first switching transistor, the first transmission end of the second switching transistor is a source electrode of the second switching transistor, the second transmission end of the second switching transistor is a drain electrode of the second switching transistor, the first transmission end of the third switching transistor is a drain electrode of the third switching transistor, and the second transmission end of the third switching transistor is a source electrode of the third switching transistor. The control end of the first switching transistor is a gate electrode of the first switching transistor, the control end of the second switching transistor is a gate electrode of the second switching transistor, and the control end of the third switching transistor is a gate electrode of the third switching transistor.

In a case that the first switching transistor and the second switching transistor are both NMOS transistors and the third switching transistor is an NMOS transistor, the first transmission end of the first switching transistor is a drain electrode of the first switching transistor, the second transmission end of the first switching transistor is a source electrode of the first switching transistor, the first transmission end of the second switching transistor is a drain electrode of the second switching transistor, the second transmission end of the second switching transistor is a source electrode of the second switching transistor, the first transmission end of the third switching transistor is a drain electrode of the third switching transistor, and the second transmission end of the third switching transistor is a source electrode of the third switching transistor. The control end of the first switching transistor is a gate electrode of the first switching transistor, the control end of the second switching transistor is a gate electrode of the second switching transistor, and the control end of the third switching transistor is a gate electrode of the third switching transistor.

In a case that the first switching transistor is a PMOS transistor, the second switching transistor is an NMOS transistor, and the third switching transistor is an NMOS transistor, the first transmission end of the first switching transistor is a drain electrode of the first switching transistor, the second transmission end of the first switching transistor is a source electrode of the first switching transistor, the first transmission end of the second switching transistor is a drain electrode of the second switching transistor, the second transmission end of the second switching transistor is a source electrode of the second switching transistor, the first transmission end of the third switching transistor is a drain electrode of the third switching transistor, and the second transmission end of the third switching transistor is a source electrode of the third switching transistor. The control end of the first switching transistor is a gate electrode of the first switching transistor, the control end of the second switching transistor is a gate electrode of the second switching transistor, and the control end of the third switching transistor is a gate electrode of the third switching transistor.

Illustratively, as shown in FIG. 1, the first switching transistor and the second switching transistor are a PMOS transistor Q1 and a PMOS transistor Q2 respectively, and the third switching transistor is an NMOS transistor Q3. The gate electrode of the PMOS transistor Q1 is connected to the drive enable end of the buck-boost controller. The PMOS transistor Q2 and the NMOS transistor Q3 are connected to form a complementary push-pull circuit. Two input ends of the complementary push-pull circuit are the gate electrode of the PMOS transistor Q2 and the gate electrode of the NMOS transistor Q3, respectively. An output end of the complementary push-pull circuit is a connection node of the drain electrode of the PMOS transistor Q2 and the drain electrode of the NMOS transistor Q3. The output end of the complementary push-pull circuit is connected to the battery B0 through the inductor L1. The battery B0 is connected in parallel with the first capacitor C1, and the first capacitor C1 is further connected to the inductor L1 to provide a voltage stabilization and filtration effect. In the charging mode, the inductor L1 further provides a voltage step-down and filtration effect.

In summary, in a process of controlling, by the buck-boost controller, the second switching transistor Q2 and the third switching transistor Q3 to be turned on or off through the duty cycle outputted by the first switch drive end and the duty cycle outputted by the second switch drive end, actually the duty cycles for controlling each switching transistor to be turned on or off are regulated, so as to control the voltage at the connection node of the second switching transistor Q2 and the third switching transistor Q3, and then feed it back to the connection node of the first switching transistor Q1 and the second switching transistor Q2, i.e., regulate the voltage at the connection node of the first switching transistor Q1 and the second switching transistor Q2. The voltage at the system voltage node is regulated according to the voltage at the connection node of the second switching transistor Q2 and the third switching transistor Q3, and the magnitude of the charging current flowing through the inductor and/or the magnitude of the supply current flowing through the motor are controlled according to the duty cycle signals. In this way, it is able to obtain the stable charging voltage of the battery or the voltage required to drive the motor, thereby to satisfy the charging requirements of the battery and/or the driving requirements of the motor.

In an embodiment of the present disclosure, the buck-boost controller is configured to, in a case of detecting that the charging device is inserted and receiving the request to enter the driving operation mode (indicating that the motor control circuit needs to enter the driving operation mode), control the second switching transistor and the third switching transistor to regulate the voltage at the system voltage node, so as to allocate the supply current to the motor while allocating the charging current to the battery. The charging device is inserted and the stability of the battery charging state is taken into account, so the first switching transistor is turned on to input an external charging voltage, and an initial voltage at the system voltage node is the reference charging voltage or a lower voltage (because no charging command signal is received). If a current supply voltage of the battery is 4.2 V and the reference charging voltage is 5 V, the initial voltage is between 4.2 V and 5 V. In a case that the initial voltage at the system voltage node exhibits a step-down trend when the duty cycles of the second switching transistor and the third switching transistor are controlled by the buck-boost controller, the obtained target stepped-down voltage is lower than 4.2 V.

In the embodiments of the present disclosure, the buck-boost controller controls the duty cycle at the gate electrode of the second switching transistor and the duty cycle at the gate electrode of the third switching transistor, so as to regulate the voltage at the system voltage node, thereby to allocate the charging current to the battery in the charging mode while allocating, by the battery, the supply current to the motor to be driven by the motor gate driver. At this time, the motor control circuit enters the driving operation mode. As shown in FIG. 1, the output end of the motor gate driver is connected to the motor through the fourth switching transistor Q4. In the driving operation mode, the duty cycle signal PWM outputted by the motor gate driver is used to control the fourth switching transistor Q4 to be turned on or off. In order to provide the supply voltage or supply current to the motor M, the fourth switching transistor Q4, the motor M and the battery B0 are sequentially connected to form a motor driving loop. Hence, a part of the charging current allocated to the battery is further allocated to the motor, so as to charge the battery and drive the motor simultaneously. In some embodiments of the present disclosure, when the fourth switching transistor is turned on, the supply current provided by the battery flows through the fourth switching transistor and the motor to form a current loop. The battery receives the charging voltage for charging, or it is discharged to the outside. At the same time, the energy stored in the inductor is converted into electric energy at the connection node of the inductor and the battery. The electric energy is superimposed on the positive electrode of the battery, so as to increase the voltage at the system voltage node and feed it back to the gate electrode of the fourth switching transistor, thereby to drive the motor through the fourth switching transistor. When a normal state of the fourth switching transistor is not an off state and the buck-boost controller determines that the charging device is inserted, the battery is supported to be charged. Part of the supply current needs to be allocated by the battery for the normal operation of the motor, so the charging current reserved for the battery becomes smaller, and thereby the power consumption for charging the battery is reduced.

In an embodiment of the present disclosure, the buck-boost controller is configured to, in a case of detecting that the charging device is inserted and receiving the charging command signal, enable a Buck driving circuit, i.e., the buck-boost controller as a whole is switched to the Buck driving circuit. The buck-boost controller includes the Buck driving circuit, a switching circuit (including multi-way switches, such as a toggle switch, and a multiplexer), and a Boost driving circuit. In a case that the switching circuit enables the Buck driving circuit to be connected to the motor control circuit, the Buck driving circuit is sequentially connected to the first switching transistor, the second switching transistor, and the third switching transistor through the drive enable end, the first switch drive end, the second switch drive end, and the drive output end. At this time, it is determined that the buck-boost controller is switched to the Buck driving circuit.

The inductor is externally connected to the motor control circuit. The Buck driving circuit, the second switching transistor, the third switching transistor and the inductor form a step-down circuit for charging the battery. The motor control circuit enters the charging mode, and an equivalent circuit of the buck-boost controller is switched to the Buck driving circuit (which may be understood as a Buck step-down circuit or a side of the Buck step-down circuit without any load, i.e., a side of the inductor L1 away from the first capacitor C1 in FIG. 1). Hence, the buck-boost controller, the second switching transistor Q2, the third switching transistor Q3, the inductor L1 and the first capacitor C1 are sequentially connected to form a Buck closed loop (or the Buck step-down circuit), so as to step down the voltage at the system voltage node and output it across the first capacitor C1 for charging the battery.

Under the control of the duty cycle outputted by the first switch drive end and the duty cycle outputted by the second switch drive end, the inductor L1 is charged when both the second switching transistor Q2 and the third switching transistor Q3 are turned on. The inductor L1 also serves as to store energy. Hence, the second switching transistor Q2 and the third switching transistor Q3 form a step-down switch for controlling the Buck driving circuit of the buck-boost controller to be turned on or off, so as to achieve the switch charging.

The Buck driving circuit is configured to, in a process of stepping down the voltage at the system voltage node, regulate the voltage at the system voltage node to the target stepped-down voltage. Actually, feedback regulation is performed on the voltage at the system voltage node (the system voltage node is configured as a feedback end for real-time output voltage/charging voltage to ensure the normal charging of the battery), and then the voltage is divided to the connection node of the second transmission end of the second switching transistor and the first transmission end of the third switching transistor, so as to obtain the converted charging voltage. Illustratively, as shown in FIG. 1, the converted charging voltage is obtained at the connection node of the drain electrode of the second switching transistor Q2 and the drain electrode of the third switching transistor Q3. The charging voltage is outputted to the battery through the inductor, and if necessary, through the inductor and the first capacitor, so as to achieve a filtration effect.

When the voltage at the system voltage node is higher than the current supply voltage of the battery, the Buck driving circuit is enabled to step down the voltage. Through controlling the duty cycles of the second switching transistor and the third switching transistor, the battery is charged using the stepped-down voltage. The reference charging voltage is converted into the charging voltage suitable for the battery, and a more stable charging voltage is obtained automatically, so as to be compatible with a larger charging voltage transmitted by the first switching transistor (i.e., a larger charging current transmitted by the first switching transistor).

In an embodiment of the present disclosure, the buck-boost controller is configured to, in a case of detecting that no charging device is inserted and receiving the request to enter the driving operation mode (indicating that the motor control circuit needs to enter the driving operation mode), enable a Boost driving circuit, i.e., the buck-boost controller as a whole is switched to the Boost driving circuit. Since no charging device is inserted, the possibility of the buck-boost controller entering the charging mode is excluded, i.e., the possibility of receiving the charging command signal is excluded. In the embodiments of the present disclosure, the buck-boost controller includes the Buck driving circuit, the switching circuit (including multi-way switches, such as a toggle switch and a multiplexer), and the Boost driving circuit. When the switching circuit enables the Boost driving circuit to be connected to the motor control circuit, the Boost driving circuit is connected to the second switching transistor and the third switching transistor through the first switch drive end and the second switch drive end respectively. At this time, it is determined that the buck-boost controller is switched to the Boost driving circuit. The Boost driving circuit, the second switching transistor, the third switching transistor and the inductor form a step-up circuit, so as to enter the driving operation mode.

The fourth switching transistor is externally connected to the motor control circuit. A regulating operation performed by the Boost driving circuit on the input voltage is boost control, and the target stepped-up voltage is used to control the fourth switching transistor to be turned on and off. The output end of the motor gate driver is connected to the control end of the fourth switching transistor. The first transmission end of the fourth switching transistor is connected to the motor, and the second transmission end of the fourth switching transistor is grounded. The fourth switching transistor is connected to a low-side control end of the motor (a ground end of the motor). The positive electrode of the battery is connected to a power supply end of the motor to receive the supply voltage provided by the battery, and the negative electrode of the battery is grounded. The battery is used to provide the supply current to the motor. Illustratively, as shown in FIG. 1, the fourth switching transistor Q4 is an NMOS transistor. The first transmission end of the fourth switching transistor Q4 is a drain electrode of the fourth switching transistor Q4, the second transmission end of the fourth switching transistor Q4 is a source electrode of the fourth switching transistor Q4, and the control end of the fourth switching transistor Q4 is a gate electrode of the fourth switching transistor Q4. An on-resistance of an NMOS transistor is large before it is turned on, so the Boost driving circuit steps up the voltage at the gate electrode of the fourth switching transistor Q4 (i.e., the voltage at the system voltage node), so as to reduce the on-resistance of the fourth switching transistor Q4 and improve the driving capability of the fourth switching transistor Q4.

In some embodiments of the present disclosure, both the second switching transistor and the third switching transistor are turned on. No charging device is inserted, so the first switching transistor is controlled to be normally off. The equivalent circuit of the buck-boost controller is switched to the Boost driving circuit (which may be understood as a Boost step-up circuit or a side of the Boost step-up circuit without any load, i.e., a side of the inductor L1 away from the first capacitor C1 in FIG. 1). Hence, the buck-boost controller, the second switching transistor Q2, the third switching transistor Q3, the inductor L1 and the first capacitor C1 are sequentially connected to form a Boost closed loop (or the Boost step-up circuit), so as to step up the voltage at the system voltage node and feed it back to the gate electrode of the fourth switching transistor to drive the motor normally, thereby to prevent the driving capability from being affected by the high on-resistance of a single switching transistor.

Under the control of the duty cycle outputted by the first switch drive end and the duty cycle outputted by the second switch drive end, referring to FIG. 1, when both the second switching transistor Q2 and the third switching transistor Q3 are turned on, the first capacitor C1 is charged and the inductor L1 stores energy. When the second switching transistor Q2 is turned off, the connection node of the drain electrode of the second switching transistor and the drain electrode of the third switching transistor is discharged through the inductor L1 and the first capacitor C1, so as to step up the voltage at the system voltage node. Preferably, the energy stored in the inductor is converted into electric energy at the node connecting the second switching transistor Q2 and the third switching transistor Q3, and then fed back to the gate electrode of the fourth switching transistor Q4 via the system voltage node. In a process of stepping up the voltage at the system voltage node, the energy stored in the inductor L1 is superimposed on the energy of the battery to supply energy to the motor, so as to enable the voltage required by the motor gate driver to drive the motor to be higher than the voltage at the positive electrode of the battery, i.e., achieve the step-up function, reduce the on-resistance of the fourth switching transistor, and improve the driving capability of the motor.

The Boost driving circuit is configured to, in a process of stepping up the voltage at the system voltage node, perform feedback regulation on the voltage at the system voltage node, i.e., regulate the voltage at the system voltage node to the target step-up voltage, and feed the target stepped-up voltage back to the motor gate driver. The motor gate driver is configured to output the target stepped-up voltage to the fourth switching transistor and generate a duty cycle signal for controlling the rotational speed of the motor. That is, upon the receipt of the target stepped-up voltage, the motor gate driver outputs the target stepped-up voltage to the fourth switching transistor, so as to output a stable and accurate target stepped-up voltage to the gate electrode of the fourth switching transistor, and generate the duty cycle signal for controlling the rotational speed of the motor. The motor gate driver outputs the duty cycle signal to the fourth switching transistor, and the fourth switching transistor controls the motor based on the duty cycle signal. The duty cycle signal outputted by the motor gate driver is illustratively represented as the PWM signal in FIG. 1. The on-time of the fourth switching transistor Q4 is adjusted to control the motor and configure a driving state of the motor, including data about a bus voltage, a bus current, a rotor position, a rotational speed of the motor, and a phase current of a motor winding, so as to form the corresponding driving capability of the motor.

The voltage at the system voltage node is used to characterize a voltage feedback signal generated when the Boost driving circuit controls the duty cycles of the second switching transistor and the third switching transistor, so as to improve the stability and accuracy of the step-up of the voltage at the system voltage node.

In some embodiments of the present disclosure, the Boost driving circuit periodically controls the second switching transistor and the third switching transistor to turned on and off, controls the duty cycles of the second switching transistor and the third switching transistor according to the voltage feedback of the system voltage node, and controls the motor gate driver to output a corresponding duty cycle signal to the gate electrode of the fourth switching transistor. Finally, the voltage at the system voltage node is maintained to be equal to the target stepped-up voltage, e.g., a direct-current voltage of 5 V. The supply voltage of the battery is between 3.0 V and 4.2 V. Hence, the Boost driving circuit is used to achieve the step-up regulation, i.e., step up the voltage at the positive electrode of the battery. In addition, the voltage at the system voltage node is maintained at 5 V, so as to control the motor gate driver to output a stable duty cycle signal, and perform duty cycle control over the fourth switching transistor, thereby to enable the motor to operate with a relatively fixed driving capability.

In an embodiment of the present disclosure, the motor control circuit includes a linear regulator and a diode. The linear regulator is connected to the system voltage node. The linear regulator is connected to the battery via the second switching transistor and the diode. The linear regulator is connected to the battery via the second switching transistor and the inductor to form a power supply path, and the linear regulator is directly connected to the battery via the diode to form another power supply path. In the embodiments of the present disclosure, the linear regulator is configured to regulate the voltage inputted thereto. Illustratively, as shown in FIG. 1, the positive electrode of the battery B0 is connected to a power supply end of the linear regulator and a positive electrode of the diode D1 so that the battery supplies power to the buck-boost controller. A negative electrode of the diode D1 is connected to the linear regulator and the system voltage node, so as to enable the battery B0 to provide an electric signal to be regulated to the linear regulator, and prevent the occurrence of current backflow. The supply voltage provided by the battery B0 is inputted to the linear regulator through the second switching transistor Q2 or the diode D1.

The linear regulator is configured to, in a case that the buck-boost controller detects that a charging device is inserted and receives the charging command signal, receive the voltage transmitted by the first switching transistor, i.e., the first switching transistor which is turned on inputs the reference charging voltage to the linear regulator, specifically through the system voltage node. As shown in FIG. 1, the linear regulator is indirectly connected to the external charging device through the first switching transistor Q1 to receive the reference charging voltage, so as to form a power supply path. Charger_IN representing the reference charging voltage is inputted to the connection node of the first switching transistor Q1 and the second switching transistor Q2 via the first switching transistor Q1 which is turned on, and then transmitted to the linear regulator for regulation. Hence, in the charging mode, it is able to obtain a relatively stable internal supply voltage.

The linear regulator is configured to, in a case that the buck-boost controller detects that the charging device is inserted and receives the request to enter the driving operation mode, receive the voltage at the system voltage node. The voltage at the system voltage node includes the reference charging voltage inputted through the first switching transistor which is turned on, the voltage transmitted through the second switching transistor which is turned on (essentially including the voltage regulated and outputted by the buck-boost controller and the voltage transmitted from the battery to the system voltage node through the inductor and the second switching transistor), or the voltage provided by the battery and received through the diode (which may be the voltage at the positive electrode of the battery transmitted through the diode in a case that both the second switching transistor and the third switching transistor are turned off). Preferably, in a case that the first switching transistor is turned on, the linear regulator is partially powered through the power supply path between the diode and the battery, so as to reduce the power consumption of the battery. In the driving operation mode, the voltage transmitted through the second switching transistor is a voltage obtained through the step-up control of the buck-boost controller or a voltage transmitted from the battery through the inductor and the second switching transistor, and it also serves as part of the power supply energy.

The linear regulator is configured to, in a case that the buck-boost controller detects that no charging device is inserted and receives the request to enter the driving operation mode, receive the voltage transmitted through the second switching transistor. Actually, this voltage is a voltage received through the system voltage node and outputted by the buck-boost controller at the connection node of the second switching transistor and the third switching transistor (a voltage stepped up by the Boost driving circuit, i.e., a voltage obtained through the step-up control of the buck-boost controller), or a voltage transmitted from the battery to the system voltage node through the inductor and the second switching transistor. It should be appreciated that, in a case that the buck-boost controller detects that no charging device is inserted and receives the request to enter the driving operation mode, the first switching transistor is turned off, so no power is supplied through the first switching transistor. Hence, the power supply is achieved through the power supply path between the second switching transistor and the battery, or the voltage outputted by the buck-boost controller at the connection node of the second switching transistor and the third switching transistor. As shown in FIG. 1, the system voltage node serves as the connection node of the first switching transistor Q1 and the second switching transistor Q2. As mentioned hereinabove, the voltage at the system voltage node is fed back as the target stepped-up voltage obtained through the step-up of the Boost driving circuit, or understood as the voltage transmitted from the battery B0 through the inductor L1 and the second switching transistor Q2 which is turned on.

In summary, in the embodiments of the present disclosure, the linear regulator is provided with multiple power supply sources, e.g., the linear regulator is connected to the battery through the diode, the reference charging voltage is inputted into the linear regulator through the first switching transistor, and the linear regulator receives the voltage transmitted through the second switching transistor. In this way, it is able to provide a sufficiently large internal supply voltage for the motor control circuit in the driving operation mode, meet the power supply requirements in the charging mode, and enable the motor gate driver to drive the motor and enable the buck-boost controller to control the charging of the battery simultaneously.

The present disclosure provides in some embodiments a motor control chip, which includes the above-mentioned motor control circuit. The motor control chip is provided with a system voltage pin, the system voltage node is connected to the system voltage pin of the motor control chip, and the system voltage node is arranged inside the motor control chip. The buck-boost controller, the motor gate driver, the first switching transistor, the second switching transistor and the third switching transistor are integrated inside the motor control chip. The connection nodes among the various components and modules integrated inside the motor control chip are all arranged inside the motor control chip and connected to relevant pins of the motor control chip.

Illustratively, as shown in FIG. 2, there are connection relationships among the first capacitor C1, the inductor L1, the motor M and the battery B0. The battery B0 is connected to the motor control chip through the inductor L1, and the motor control chip is connected to the motor M through the fourth switching transistor Q4. As shown in FIG. 2, from top to bottom, the motor control chip includes a duty cycle output pin PWM_OUT, a charging voltage input pin 5V_in, a system voltage pin Vsys, a load output pin OUT, a ground pin PGND, and a battery power supply pin VBAT. Taking an application for driving the motor and charging the battery as an example, the connection structures between the pins of the motor control chip and the relevant components in the motor control circuit and the functions thereof will be described hereinafter, with reference to the above-mentioned motor control circuit. The duty cycle output pin PWM_OUT is connected between the gate electrode of the fourth switching transistor Q4 and the motor gate driver. The charging voltage input pin 5V_in is connected to the input end of the first switching transistor (i.e., the source electrode of the first switching transistor in FIG. 2) to input the reference charging voltage (Charger_IN in FIG. 2). The connection node of the first switching transistor Q1 and the second switching transistor Q2 is connected to the system voltage pin Vsys. The connection node of the second switching transistor Q2 and the third switching transistor Q3 is connected to the load output pin OUT. The source electrode of the third switching transistor Q3 is connected to the ground pin PGND. The battery power supply pin VBAT is directly connected to the battery B0. It should be appreciated that, although seven pins of the motor control chip are shown in FIG. 2, the motor control chip may include more than seven pins, for example, during the encapsulation of the motor control chip, a plurality of pins for driving the motor in a multi-phase manner may be led out from the motor gate driver.

Based on the above, as shown in FIG. 2, the motor control chip includes the buck-boost controller, the motor gate driver, the first switching transistor Q1, the second switching transistor Q2, and the third switching transistor Q3. The first switching transistor Q1, the second switching transistor Q2 and the third switching transistor Q3 are all connected to the buck-boost controller. The drain electrode of the first switching transistor Q1 is connected to the drain electrode of the second switching transistor Q2. The source electrode of the second switching transistor Q2 is connected to the drain electrode of the third switching transistor Q3. The buck-boost controller is configured to, in a case of detecting that the charging device is inserted and receiving the charging command signal, turn on the first switching transistor Q1 to input the reference charging voltage external to the motor control chip. Alternatively, the buck-boost controller is configured to, in a case of detecting that the charging device is inserted and receiving the request to enter the driving operation mode, turn on the first switching transistor Q1 to input the reference charging voltage external to the motor control chip.

The motor control chip includes the system voltage pin Vsys. Both the first switching transistor Q1 and the second switching transistor Q2 are connected to the system voltage pin Vsys. The system voltage pin Vsys is connected to the battery B0 external to the motor control chip through the second switching transistor Q2 and the inductor L1. The buck-boost controller is configured to, in a case of detecting that the charging device is inserted and receiving the request to enter the driving operation mode, control the second switching transistor Q2 and the third switching transistor Q3 to charge the battery and allocate the supply current to the motor. At this time, the second switching transistor Q2 and the third switching transistor Q3 are controlled to be turned on simultaneously to output a small charging current to the battery for charging, and meanwhile the motor operates according to a predetermined driving capability (e.g., a supply level of 5 V is maintained).

The buck-boost controller is configured to, in a case of detecting that the charging device is inserted and receiving the charging command signal, control the second switching transistor Q2 and the third switching transistor Q3 to step down the voltage at the system voltage pin Vsys to a target stepped-down voltage, and convert the target stepped-down voltage into the charging voltage for the battery B0 external to the motor control chip. The charging voltage is outputted from the load output pin OUT to charge the battery B0 external to the motor control chip in combination with the inductor. The battery B0 external to the motor control chip is connected to the motor control chip through the inductor L1. The buck-boost controller is configured to, in a case of detecting that no charging device is inserted and receiving the request to enter the driving operation mode, turn off the first switching transistor Q1, and control the second switching transistor Q2 and the third switching transistor Q3 to step up the voltage at the system voltage pin Vsys to a target stepped-up voltage, so that the motor gate driver outputs the target stepped-up voltage to the fourth switching transistor Q4 and the fourth switching transistor Q4 controls the operation of the motor. At this time, a corresponding duty cycle signal outputted by the motor gate driver is used to control the rotational speed of the motor, and the voltage in the corresponding duty cycle signal includes the target stepped-up voltage. The target stepped-up voltage is applied to the gate electrode of the fourth switching transistor, so as to reduce the on-resistance of the fourth switching transistor and turn the fourth switching transistor on.

As shown in FIG. 2, in the motor control chip, the connection node of the first switching transistor Q1 and the second switching transistor Q2 (i.e., the above-mentioned system voltage node) is connected to the system voltage pin Vsys. The system voltage pin Vsys is grounded through a capacitor C2. The system voltage pin Vsys is connected to the positive electrode of the battery B0 via the second switching transistor Q2 and the inductor L1 in sequence. The second switching transistor Q2 adjusts an on-time to affect the charge/discharge amount of the battery B0, and the inductor L1 has an energy storage effect to affect the charge/discharge amount of the battery B0. In a case that the voltage at the system voltage pin is dynamically regulated by the buck-boost controller, both the supply voltage of the battery and the supply voltage of the motor may be stabilized. Hence, the operation of the motor is not affected in a case that no charging device is inserted or the charging device is inserted.

The present disclosure provides in some embodiments a motor control system, which includes the above-mentioned motor control chip. The motor control chip is externally connected to an inductor, a motor, a battery, and a fourth switching transistor. The fourth switching transistor, the motor, the battery, the inductor and the motor control chip are sequentially connected to form a loop. The second switching transistor, the third switching transistor, the inductor and the battery are sequentially connected to form a battery charging and discharging loop. The motor control chip further includes a linear regulator and a diode. The linear regulator is connected to the battery via the second switching transistor and via the diode, so that a supply voltage of the battery is inputted to the linear regulator through the second switching transistor or the diode. The linear regulator is configured to regulate the voltage inputted into the linear regulator to provide an internal supply voltage for the motor control chip.

In summary, the voltage at the system voltage pin is regulated through the inductor connected externally to the motor control chip as well as the two switching transistors and the buck-boost controller built in the motor control chip, so as to prevent the operation of the motor from being affected in a process of stepping down the voltage to charge the battery, and maintain the voltage at the system voltage node for the operation of the motor through step-up regulation in a case that the battery does not need to be charged. As a result, it is able to solve the problems of a low supply voltage and an unstable voltage caused when the battery is used for a long time period, charge the battery, and prevent the motor from being not driven due to a large on-resistance of the switching transistor in the motor control chip.

Specifically, in a case that the inductor, the motor, the battery and the fourth switching transistor are all arranged external to the motor control chip, the fourth switching transistor, the motor, the battery, the inductor and the motor control chip are sequentially connected to form a loop, and the second switching transistor, the third switching transistor, the inductor and the battery are sequentially connected to form a battery charging and discharging loop. As shown in FIG. 2, the fourth switching transistor Q4, the motor M, the battery B0, the inductor L1 and the motor control chip are sequentially connected to form a loop, and outside the motor control chip, the fourth switching transistor Q4, the motor M and the battery B0 are sequentially connected to form a motor driving loop. In some embodiments of the present disclosure, as shown in FIG. 2, the second switching transistor Q2, the third switching transistor Q3, the inductor L1, the first capacitor C1 and the battery B0 are sequentially connected to form a battery charging and discharging loop. A charging and discharging path is formed from the system voltage pin Vsys to the battery B0 through the second switching transistor Q2, the inductor L1 and the first capacitor C1 in sequence. The battery B0 and the first capacitor C1 are connected in parallel and then connected to the load output pin OUT of the motor control chip through the inductor L1. The voltage outputted from the load output pin OUT of the motor control chip passes through the inductor L1 and is then applied to the positive electrode of the battery B0 and the motor M. In the embodiments of the present disclosure, a switch inside the motor control chip is formed through connecting the second switching transistor Q2 and the third switching transistor Q3. The positive electrode of the battery B0 and the motor M are connected to the switch inside the motor control chip. The buck-boost controller is switched between the Boost driving circuit for stepping up the voltage and the Buck driving circuit for stepping down the voltage, and the inductor L1 serves as to store energy, so the buck-boost controller outputs the duty cycle signals to the second switching transistor Q2 and the third switching transistor Q3, so as to adjust the on-time and off-time of each of the second switching transistor Q2 and the third switching transistor Q3. In this way, based on the energy released by the inductor, it is able to charge the battery in a case that a corresponding step-down logic is formed by the Buck driving circuit, or drive the motor in a case that a corresponding step-up logic is formed by the Boost driving circuit.

The motor control chip further includes a linear regulator and a diode. The linear regulator is connected to the system voltage pin. The linear regulator is connected to the battery via the second switching transistor and the diode, so that the supply voltage of the battery is inputted to the linear regulator through the second switching transistor or the diode. The linear regulator is configured to regulate the voltage inputted to the linear regulator to provide an internal supply voltage for the motor control chip. The linear regulator is connected to the battery through the second switching transistor and the inductor so as to form a power supply path, and the linear regulator is directly connected to the battery through the diode so as to form another power supply path. Regardless of the power supply paths, the linear regulator is connected to the system voltage pin Vsys, and then the voltage at the system voltage pin Vsys is inputted to the linear regulator. Illustratively, as shown in FIG. 2, the load output pin OUT of the motor control chip and the ground pin PGND of the motor control chip are provided. The load output pin OUT is connected to one end of the inductor L1, the other end of the inductor L1 is connected to one end of the first capacitor C1, the other end of the first capacitor C1 and the ground pin PGND are both grounded, the connection node of the inductor L1 and the first capacitor C1 is connected to the positive electrode of the battery B0, and the negative electrode of the battery B0 is grounded, so that a power supply path is formed between the battery B0 and the load output pin OUT, i.e., a power supply path from the linear regulator to the battery through the second switching transistor and the inductor, and also a charging path between the load output pin OUT and the battery B0 is formed in the charging mode. The battery power supply pin VBAT of the motor control chip is connected to the positive electrode of the battery B0. The battery power supply pin VBAT is connected to a positive electrode of the diode D1, and a negative electrode of the diode D1 is connected to the system voltage pin Vsys, so that a power supply path is formed between the battery B0 and the battery power supply pin VBAT, i.e., the other power supply path from the linear regulator to the battery through the diode.

Referring to FIG. 2, the buck-boost controller is configured to, in a case of detecting that the charging device is inserted and receiving the charging command signal, turn on the first switching transistor Q1, so as to input the reference charging voltage external to the motor control chip to the linear regulator through the system voltage pin Vsys. As shown in FIG. 2, the linear regulator is indirectly connected to the external charging device through the first switching transistor Q1 to receive the reference charging voltage, so as to form a charging path. Charger_IN representing the reference charging voltage passes through the turned-on first switching transistor Q1, is inputted to the connection node of the first switching transistor Q1 and the second switching transistor Q2, and then transmitted to the linear regulator for regulation, so as to obtain a relatively stable internal supply voltage in the charging mode.

The buck-boost controller is configured to, in a case of detecting that the charging device is inserted and receiving the request to enter the driving operation mode, turn on the first switching transistor Q1, so that the reference charging voltage provided by the charging device external to the motor control chip is inputted to the linear regulator through the system voltage pin Vsys, or the voltage transmitted through the second switching transistor which is turned on (essentially including the voltage regulated and outputted by the buck-boost controller and the voltage transmitted from the battery to the system voltage node through the inductor and the second switching transistor) is inputted, or the voltage provided by the battery and received through the diode is inputted in a case that both the second switching transistor and the third switching transistor are turned off.

The motor control chip includes a battery power supply pin VBAT. The buck-boost controller further includes a power supply end. The positive electrode of the battery B0 external to the motor control chip is connected to the battery power supply pin VBAT. The battery power supply pin VBAT is connected to the power supply end and the positive electrode of the diode D1. The negative electrode of the diode D1 is connected to the linear regulator and the system voltage pin Vsys, so that the battery B0 external to the motor control chip is also used to supply power to the linear regulator and the buck-boost controller. The charging path of the linear regulator connected to the external charging device through the first switching transistor Q1 and the power supply path of the linear regulator connected to the battery through the second switching transistor and the inductor are connected at the system voltage pin Vsys.

The linear regulator is configured to, in a case that the buck-boost controller detects that no charging device is inserted and receives the request to enter the driving operation mode, receive the voltage transmitted through the second switching transistor. Actually, this voltage is a voltage received through the system voltage node and outputted by the buck-boost controller at the connection node of the second switching transistor and the third switching transistor (a voltage stepped up by the Boost driving circuit, i.e., a voltage obtained through the step-up control of the buck-boost controller). In some embodiments of the present disclosure, the linear regulator receives the voltage transmitted from the battery to the system voltage pin Vsys through the inductor L1 and the second switching transistor Q2. It should be appreciated that, in a case that the buck-boost controller detects that no charging device is inserted and receives the request to enter the driving operation mode, the first switching transistor is turned off, so no power supply is inputted through the first switching transistor. Hence, the power is supplied through the power supply path between the second switching transistor and the battery, or the voltage outputted by the buck-boost controller at the connection node of the second switching transistor and the third switching transistor.

In an embodiment of the present disclosure, the motor control chip includes a duty cycle output pin. The duty cycle output pin is connected to the output end of the motor gate driver inside the motor control chip. The duty cycle output pin is connected to the control end of the fourth switching transistor outside the motor control chip, and the output end of the motor gate driver is connected to the motor through the fourth switching transistor, so that the fourth switching transistor, the motor, and the battery are sequentially connected to form a motor driving loop. Illustratively, as shown in FIG. 2, the fourth switching transistor Q4 is an NMOS transistor, the duty cycle output pin PWM_OUT is connected to the gate electrode of the fourth switching transistor Q4, the source electrode of the fourth switching transistor Q4 is grounded, the drain electrode of the fourth switching transistor Q4 is connected to the motor M, and the motor M is further connected to the battery B0.

The motor gate driver is configured to, based on a feedback of the voltage at the system voltage pin, output a corresponding duty cycle signal to the control end of the fourth switching transistor, so as to control the operation of the motor, e.g., the rotational speed of the motor, through adjusting the on-time and off-time of the fourth switching transistor. The voltage in the corresponding duty cycle signal includes the target stepped-up voltage, so as to reduce the on-resistance of the fourth switching transistor.

Specifically, the buck-boost controller is configured to, in a case of detecting that no charging device is inserted and receiving the request to enter the driving operation mode, enable a Boost driving circuit. Correspondingly, as shown in FIG. 2, the buck-boost controller, the second switching transistor Q2, the third switching transistor Q3 and the inductor L1 form a step-up circuit. In the motor control chip, the Boost driving circuit is configured to, in a process of stepping up the voltage at the system voltage node, perform feedback regulation on the voltage at the system voltage node, so as to regulate the voltage at the system voltage node to the target stepped-up voltage. The target stepped-up voltage is regulated by the buck-boost controller to be higher than an initial voltage at the system voltage node or a reference input voltage, e.g., a voltage of 5 V, which may be higher than a maximum voltage provided by a single lithium battery for powering a small household appliance or a toy. When the initial voltage at the system voltage node is an input voltage of the step-up circuit, the target stepped-up voltage is an output voltage of the step-up circuit, and it is fed back to the motor gate driver. The motor gate driver configures the target stepped-up voltage as the voltage at the gate electrode of the fourth switching transistor, so as to at least reduce the on-resistance of the fourth switching transistor. Based on the above, the motor gate driver outputs the duty cycle signal to the fourth switching transistor, so as to control the operation of the motor based on the duty cycle signal.

In some embodiments of the present disclosure, the buck-boost controller is configured to, in a case of detecting that the charging device is inserted and receiving the request to enter the driving operation mode (indicating that the motor control circuit needs to enter the driving operation mode), control the second switching transistor and the third switching transistor to regulate the voltage at the system voltage pin Vsys. The charging device is inserted and the stability of the battery charging state is taken into account, so the first switching transistor is turned on to input an external charging voltage, and the initial voltage at the system voltage pin Vsys is the reference charging voltage or a lower voltage (because no charging command signal is received). The buck-boost controller controls the duty cycle of the second switching transistor Q2 and the duty cycle of the third switching transistor Q3, so as to regulate the voltage at the system voltage pin Vsys, thereby to allocate, by the battery, the supply current to the motor to be driven by the motor gate driver while allocating the charging current to the battery. After the voltage at the system voltage pin Vsys is fed back to the motor gate driver, when the fourth switching transistor Q4 is turned on, the supply current provided by the battery flows through the fourth switching transistor Q4 and the motor M to form a current loop. It should be appreciated that, the energy stored in the inductor L1 may be converted into electric energy at the connection node of the inductor and the battery B0. The electric energy is superimposed on the positive electrode of the battery B0, and fed back to the gate electrode of the fourth switching transistor Q4 via the system voltage pin Vsys, so as to drive the motor M. In the embodiments of the present disclosure, the motor control chip may be set to enter the driving operation mode, so the fourth switching transistor Q4 is not maintained in the off state. Alternatively, in the embodiments of the present disclosure, in order to drive the motor to operate normally, the voltage at the system voltage pin Vsys is stepped up to turn on the fourth switching transistor Q4 according to a certain duty cycle. When the battery B0 is allowed to be charged simultaneously, the battery needs to allocate part of the supply current to the motor M, so the charging current reserved for the battery B0 becomes smaller, and thereby the power consumption for charging the battery B0 is reduced.

In an embodiment of the present disclosure, the motor control chip includes a buck-boost controller. The buck-boost controller is configured to, in a case of detecting that the charging device is inserted and receiving the charging command signal, charge the battery using the converted charging voltage, turn off the second switching transistor and the third switching transistor when the battery is fully charged, and then trigger the motor control chip to enter a standby state or a sleep state, so that the internal supply voltage of the motor control chip comes from the battery. In an ideal state, the supply voltage of the motor control chip is set to be the supply voltage of the battery. Specifically, referring to FIG. 2, in a case of detecting that the charging device is inserted and receiving the charging command signal, in a process of stepping down the voltage at the system voltage pin Vsys, the buck-boost controller converts the voltage at the system voltage pin Vsys into a voltage outputted by the load output pin OUT, and transmits the voltage through the inductor L1 to the battery B0 external to the motor control chip. When the voltage at the system voltage pin Vsys is stepped down to the target stepped-down voltage, the voltage at the load output pin OUT is the charging voltage of the battery B0 external to the motor control chip, which may be lower than a rated supply voltage provided by the battery B0 when the battery B0 is fully charged. The system voltage pin Vsys is connected to the second capacitor C2 for filtering and voltage stabilization. Based on the target stepped-down voltage, when the battery is fully charged, the second switching transistor Q2 and the third switching transistor Q3 are turned off to stop charging the battery. At this time, the buck converter built in the buck-boost controller and the boost converter built in the buck-boost controller are turned off, and the motor control chip is in a standby state. If no charging device is inserted, the first switching transistor Q1 is turned off. In the standby state, the motor gate driver controls the fourth switching transistor to be turned off, so as to stop driving the motor M. Hence, after the motor control chip enters the standby state, the buck-boost controller is triggered to turn off both the second switching transistor and the third switching transistor, no charging management is performed, no boosting is performed, and the driving of the motor is stopped. At this time, the battery supplies power to the buck-boost controller and the motor through the inductor. Alternatively, the voltage is inputted to the linear regulator through the diode for regulation, and then a corresponding voltage is outputted as the internal supply voltage of the motor control chip in the standby state, so that the internal supply voltage of the motor control chip is configured as the supply voltage of the battery or a stable voltage (processed by the linear regulator or provided by another reference source) lower than the supply voltage of the battery, and thereby the motor control chip is guided to enter a low-power standby state.

In an embodiment of the present disclosure, the motor control chip includes a charging voltage input pin. When the charging voltage input pin of the motor control chip is physically connected to the charging device, the insertion of the charging device is detected, and when the charging voltage input pin of the motor control chip inputs the reference charging voltage, the reception of the charging command signal is determined, so as to form a charging path between the charging device and the motor control chip. If the charging path is associated with the linear regulator, referring to FIG. 2, the linear regulator is connected to the external charging device through the first switching transistor Q1 to receive the reference charging voltage, and a charging path between the charging device and the motor control chip is formed. Specifically, Charger_IN representing the reference charging voltage passes through the charging voltage input pin 5V_in and the first switching transistor Q1 which is turned on, is inputted to the connection node of the first switching transistor Q1 and the second switching transistor Q2, and then transmitted to the linear regulator for regulation, so as to provide the internal supply voltage for the motor control chip in the charging mode through the linear regulator.

Based on the above, the present disclosure further provides in some embodiments a motor control system, which includes an inductor, a motor, a battery, a fourth switching transistor and the above-mentioned motor control circuit. Alternatively, the motor control system includes an inductor, a motor, a battery, a fourth switching transistor and the above-mentioned motor control chip. Regardless of whether the motor control system is configured to include the motor control chip, the inductor, the motor, and the battery and the relevant pins are set as mentioned hereinabove for the connection among the components inside and outside the motor control chip, or the motor control system is configured to include the fourth switching transistor, the inductor, the motor, the battery and the above-mentioned motor control circuit, the buck-boost controller, in a case of detecting that the charging device is inserted and receiving the request to enter the driving operation mode, controls the second switching transistor and the third switching transistor, so as to charge the battery and allocate the supply current to the motor. Alternatively, in a case of detecting that the charging device is inserted and receiving the charging command signal, or in a case of detecting that no charging device is inserted and receiving the request to enter the driving operation mode, the buck-boost controller controls the second switching transistor and the third switching transistor, so as to step down or step up the voltage at the system voltage node, e.g., perform duty cycle control on parameters such as the voltage generated at the system voltage pin using an internal switching logic circuit in combination with the inductor. Hence, through the motor control circuit or the motor control chip in combination with the inductor, it is able to achieve the switch charging and the voltage boosting.

Although the above description has been given in conjunction with the embodiments a person skilled in the art may make various alternations, modifications, substitutions and improvements without departing from the principle and spirit of the present disclosure, which also falls within the scope of the present disclosure.

What is claimed is:

1. A motor control circuit, comprising a buck-boost controller, a motor gate driver, a first switching transistor, a second switching transistor, and a third switching transistor;
wherein the first switching transistor, the second switching transistor, and the third switching transistor are all connected to the buck-boost controller, the first switching transistor is connected to the second switching transistor, and the second switching transistor is connected to the third switching transistor;
the first switching transistor is connected to the second switching transistor at a system voltage node;
the buck-boost controller is configured to, in a case of detecting that a charging device is inserted and receiving a charging command signal, turn on the first switching transistor to input a voltage to the system voltage node, or in a case of detecting that the charging device is inserted and receiving a request to enter a driving operation mode, turn on the first switching transistor to input a voltage to the system voltage node;
the buck-boost controller is configured to, in a case of detecting that the charging device is inserted and receiving the request to enter the driving operation mode, control the second switching transistor and the third switching transistor to charge a battery and allocate a supply current to a motor;
the buck-boost controller is configured to, in a case of detecting that the charging device is inserted and receiving the charging command signal, control the second switching transistor and the third switching transistor to step down a voltage at the system voltage node to a target stepped-down voltage, and convert the target stepped-down voltage into a charging voltage for the battery; and
the buck-boost controller is configured to, in a case of detecting that no charging device is inserted and receiving the request to enter the driving operation mode, turn off the first switching transistor, and control the second switching transistor and the third switching transistor to step up the voltage at the system voltage node to a target stepped-up voltage, to allow that the motor gate driver indirectly controls operation of the motor according to the target stepped-up voltage.

2. The motor control circuit according to claim 1, wherein the buck-boost controller is configured to, in a case of detecting that the charging device is inserted and receiving the charging command signal, charge the battery using the charging voltage obtained through conversion, and turn off the second switching transistor and the third switching transistor to stop charging the battery when the battery is fully charged.

3. The motor control circuit according to claim 1, wherein a connection node of the second switching transistor and the third switching transistor is connected to the battery through an inductor, to allow that a charging and discharging path is formed between the connection node of the second switching transistor and the third switching transistor and the battery.

4. The motor control circuit according to claim 3, wherein the buck-boost controller comprises a drive enable end, a first switch drive end, a second switch drive end, and a drive output end;
a first transmission end of the first switching transistor is configured to receive a reference charging voltage;
a control end of the first switching transistor is connected to the drive enable end, to allow that the drive enable end controls the first switching transistor to be turned on or off; and
a second transmission end of the first switching transistor and a first transmission end of the second switching transistor are connected at the system voltage node, a control end of the second switching transistor is connected to the first switch drive end, a second transmission end of the second switching transistor and a first transmission end of the third switching transistor are connected to one end of the inductor, the other end of the inductor is connected to a positive electrode of the battery, a control end of the third switching transistor is connected to the second switch drive end, a connection node of the second transmission end of the second switching transistor and the first transmission end of the third switching transistor are connected to the drive output end, and a second transmission end of the third switching transistor is grounded, to allow that the second switching transistor is controlled through a duty cycle signal outputted by the first switch drive end and control the third switching transistor through a duty cycle signal outputted by the second switch drive end.

5. The motor control circuit according to claim 4, wherein the buck-boost controller is configured to enable a Buck driving circuit in a case of detecting that the charging device is inserted and receiving the charging command signal, wherein the buck-boost controller comprises the Buck driving circuit, and the Buck driving circuit, the second switching transistor, the third switching transistor, and the inductor form a step-down circuit for charging the battery; the motor control circuit is externally connected to the inductor; and
the Buck driving circuit is configured to, in a process of stepping down the voltage at the system voltage node, regulate the voltage at the system voltage node to the target stepped-down voltage, and divide the target stepped-down voltage to the connection node of the second transmission end of the second switching transistor and the first transmission end of the third switching transistor, to output the stepped-down voltage to the battery through the inductor; wherein the battery is charged by the voltage at the connection node of the second transmission end of the second switching transistor and the first transmission end of the third switching transistor through the inductor.

6. The motor control circuit according to claim 4, wherein the buck-boost controller is configured to, in a case of detecting that no charging device is inserted and receiving the request to enter the driving operation mode, enable a Boost driving circuit, wherein the buck-boost controller comprises the Boost driving circuit, and the Boost driving circuit, the second switching transistor, the third switching transistor, and the inductor form a step-up circuit; the motor control circuit is externally connected to a fourth switching transistor;
an output end of the motor gate driver is connected to a control end of the fourth switching transistor, a first transmission end of the fourth switching transistor is connected to the motor, a second transmission end of the fourth switching transistor is grounded, the positive electrode of the battery is connected to a power supply end of the motor, and a negative electrode of the battery is grounded;
the Boost driving circuit is configured to, in a process of stepping up the voltage at the system voltage node, perform feedback regulation on the voltage at the system voltage node, to regulate the voltage at the system voltage node to the target stepped-up voltage and feed the target stepped-up voltage back to the motor gate driver; and
the motor gate driver is configured to output the target stepped-up voltage to the fourth switching transistor and form a duty cycle signal for controlling a rotational speed of the motor.

7. The motor control circuit according to claim 4, further comprising a linear regulator and a diode; wherein the linear regulator is connected to the system voltage node; the linear regulator is connected to the battery via the second switching transistor and the diode; the linear regulator is configured to regulate a voltage inputted into the linear regulator;
the linear regulator is configured to receive a voltage from the first switching transistor in a case that the buck-boost controller detects that a charging device is inserted and receives the charging command signal;
the linear regulator is configured to receive the voltage at the system voltage node in a case that the buck-boost controller detects that a charging device is inserted and receives the request to enter the driving operation mode; and
the linear regulator is configured to receive a voltage from the second switching transistor in a case that the buck-boost controller detects that no charging device is inserted and receives the request to enter the driving operation mode.

8. A motor control chip, comprising the motor control circuit according to claim 1, wherein the motor control chip is provided with a system voltage pin, and the system voltage node is connected to the system voltage pin of the motor control chip.

9. A motor control system, comprising the motor control chip according to claim 8, wherein the motor control chip are externally connected to an inductor, a motor, a battery, and a fourth switching transistor;
the fourth switching transistor, the motor, the battery, the inductor, and the motor control chip are sequentially connected to form a loop;
the second switching transistor, the third switching transistor, the inductor, and the battery are sequentially connected to form a battery charging and discharging loop; and
the motor control chip further comprises a linear regulator and a diode, and the linear regulator is connected to the battery via the second switching transistor and the diode, to allow that a supply voltage of the battery is inputted to the linear regulator through the second switching transistor or the diode, wherein the linear regulator is configured to regulate a voltage inputted into the linear regulator to provide an internal supply voltage for the motor control chip.

10. The motor control system according to claim 9, wherein the motor control chip comprises a duty cycle output pin, the duty cycle output pin is connected to an output end of the motor gate driver inside the motor control chip, the duty cycle output pin is connected to a control end of the fourth switching transistor outside the motor control chip, and the output end of the motor gate driver is connected to the motor through the fourth switching transistor, to allow that the fourth switching transistor, the motor, and the battery are sequentially connected to form a motor driving loop; and
the motor gate driver is configured to output a corresponding duty cycle signal to the control end of the fourth switching transistor based on a feedback of a voltage at the system voltage pin, to control operation of the motor through adjusting an on-time and an off-time of the fourth switching transistor, wherein a voltage in the corresponding duty cycle signal comprises a target stepped-up voltage.

11. The motor control system according to claim 9, wherein the buck-boost controller is configured to, in a case of detecting that a charging device is inserted and receiving a charging command signal, charge the battery using a charging voltage obtained through conversion, turn off the second switching transistor and the third switching transistor when the battery is fully charged, and trigger the motor control chip to enter a standby state or a sleep state, to allow that the internal supply voltage of the motor control chip is applied by the battery.

12. The motor control system according to claim 11, wherein the motor control chip comprises a charging voltage input pin, and insertion of the charging device is detected when the charging voltage input pin of the motor control chip is physically connected to the charging device; and reception of the charging command signal is determined when a reference charging voltage is inputted to the charging voltage input pin of the motor control chip, and a charging path is formed between the charging device and the motor control chip.

13. A motor control system, wherein the motor control system comprises a fourth switching transistor, an inductor, a motor, a battery, and the motor control circuit according to claim 1.

14. A motor control system, wherein the motor control system comprises a fourth switching transistor, an inductor, a motor, a battery, and the motor control chip according to claim 8.
